(19) United States
(12) Patent Application Publication
(10) Pub. No.: US 2026/0315821 A1
(43) Pub. Date: Oct. 15, 2026

(54) Phototherapy Pad

(71) Applicant: Shenzhen Rainbow Light Medical Equipment Co., Ltd., Shenzhen City (CN)

(72) Inventors: Alain Dijkstra, Amstelveen (NL); Cao Jiaming, Shenzhen City (CN); Chu Zhanghui, Shenzhen City (CN); Tan Xiaoping, Shenzhen City (CN); Yin Zhichao, Shenzhen City (CN)

(21) Appl. No.: 19/643,044

(22) Filed: Apr. 9, 2026

(30) Foreign Application Priority Data
Apr. 11, 2025 (CN) 202520688992.5

(51) Int. Cl. A61N 5/06

(52) U.S. Cl. CPC A61N 5/0617; A61N 2005/0632; A61N 2005/0647

(57) ABSTRACT

The present invention relates to a phototherapy pad. The phototherapy pad includes a body, a charging assembly, and a fixing seat. The body has a peripheral edge with a receiving notch formed therein. The charging assembly includes a charging interface fixedly arranged within the receiving notch and electrically connected to the body. The fixing seat is attached to the body at the receiving notch and includes an accommodating cavity configured to receive the charging interface, an insertion hole aligned with the charging interface, and at least one limiting structure arranged within the accommodating cavity. The limiting structure engages and retains the charging interface in a fixed position relative to the insertion hole. By securing the charging interface at the receiving notch through the fixing seat, loosening of the charging interface during repeated plugging and unplugging of a charging cable can be reduced.

### TECHNICAL FIELD

The present invention relates to phototherapy. More specifically, the present invention relates to a phototherapy pad.

### BACKGROUND

Presently, the phototherapy devices have been used for delivering light of selected wavelengths to a treatment area of a user for purposes such as scalp care, pain relief, and stimulation of blood circulation. In some applications, a phototherapy pad is integrated into a wearable article, such as a cap, so that light can be applied to a target area in a convenient and hands-free manner. Such devices commonly include a flexible body carrying light-emitting components and an electrical interface for supplying charging power.

The conventional phototherapy pads are formed from soft or flexible materials, for example, silicone, fabric, or other deformable layers, in order to improve comfort and conformity to a user's body. These devices generally require periodic recharging, and hence a charging interface is typically mounted at or near an edge region of the pad so that a charging cable can be repeatedly inserted and removed during normal use. However, repeated charging operations can subject the surrounding flexible material to localized pulling, compression, and bending forces.

Over time, the repeated plugging and unplugging of a charging cable causes the portion of the pad around the charging interface to become damaged, deformed, or torn. In some cases, the charging interface itself becomes loosened relative to the pad body, which can lead to poor electrical contact, reduced charging efficiency, intermittent charging, or complete charging failure. Such issues may negatively affect product appearance, reliability, and service life, and may also reduce user convenience.

Therefore, there is a need for a phototherapy pad to overcome a few or all drawbacks of the existing technologies.

### STATEMENT OF THE INVENTION

An object of the present invention is to provide a phototherapy pad.

Another object of the present invention is to provide a phototherapy pad that improves the structural stability of the charging region.

Another object of the present invention is to provide a phototherapy pad that reduces the damage to the body caused by repeated plugging and unplugging of a charging cable.

One more object of the present invention is to provide a phototherapy pad having an improved structure that resists loosening, displacement, or deterioration of charging-related portions over time.

Yet another object of the present invention is to provide a phototherapy pad that offers improved charging convenience while maintaining user comfort and product appearance.

Yet another object of the present invention is to provide a phototherapy pad with a phototherapy cap that improves usability and treatment convenience for a user.

According to the present invention, there is provided a phototherapy pad. The phototherapy pad may include a body, a charging assembly, and a fixing seat. The body may have a peripheral edge in which a receiving notch is formed. The charging assembly may include a charging interface fixedly arranged within the receiving notch and electrically connected to the body. The fixing seat may be attached to the body at the receiving notch and may include an accommodating cavity configured to receive the charging interface, an insertion hole aligned with the charging interface, and at least one limiting structure arranged within the accommodating cavity.

The fixing seat may retain the charging interface in a fixed position relative to the insertion hole, so that loosening of the charging interface during repeated plugging and unplugging of a charging cable is reduced. In this manner, damage to the body in a charging region may be reduced, and reliability of the electrical connection may be improved.

In the present aspect, the fixing seat may include a first cover plate, a second cover plate arranged opposite to the first cover plate, and a side cover plate arranged to join a portion of the first cover plate to the second cover plate to configure the accommodating cavity therein. Further, at least one limiting structure may be provided on an inner side of the first cover plate adjacent to the receiving notch and may engage the charging interface.

In an aspect of the invention, the limiting structure may include a limiting protrusion configured to limit movement of the charging interface in a length direction. The limiting protrusion may be arranged on a rear portion of the inner side of the first cover plate and may engage a first stepped groove of the charging interface.

In another aspect, at least one limiting structure may include limiting brackets arranged on the inner side of the first cover plate adjacent to the insertion hole. The limiting brackets may be configured to limit movement of the charging interface in a lateral direction and may be arranged on opposite sides of the charging interface along a length direction of the insertion hole to laterally restrain the charging interface.

Further, the first cover plate and the second cover plate may be detachably connected to the body using a plurality of connecting posts, a plurality of first connecting holes, a plurality of second connecting holes and a plurality of fasteners. The plurality of connecting posts may be provided on the first cover plate. The plurality of first connecting holes may be arranged on the second cover plate corresponding to the plurality of connecting posts. The plurality of second connecting holes may be arranged on the body corresponding to the plurality of connecting posts and the plurality of first connecting holes. Further, the plurality of fasteners may be passed through the plurality of first connecting holes and the plurality of second connecting holes to engage with the plurality of connecting posts, thereby clamping the body between the first cover plate and the second cover plate.

In another aspect of the invention, the body may include a second stepped groove at an opening of the receiving notch. The side cover plate may be inserted into the second stepped groove to flush the side cover plate with the peripheral edge of the body.

In an aspect of the invention, a phototherapy pad may be configured for arrangement within a phototherapy cap having a cap body. The phototherapy pad may be arranged on an inner side of the cap body along an edge adjacent to a notch of the cap body such that a receiving notch of the phototherapy pad may be accessed through the notch of the cap body. This arrangement allows to improve charging convenience, while maintaining the phototherapy pad in a position suitable for use within the cap body.

In some embodiments, a phototherapy cap may include a cap body adapted to be worn on a user's head and a phototherapy pad arranged on an inner side of the cap body. The cap body may have a notch at a rear portion thereof for connection of an elastic band. The phototherapy pad may be positioned along an edge adjacent to the notch so that a receiving notch of the phototherapy pad may be accessible through the notch of the cap body, thereby facilitating charging access.

### BRIEF DESCRIPTION OF DRAWINGS

Other features and advantages of the invention will become apparent when reading the detailed description given below, purely by way of example and in a non-limitative manner, referring to the following figures:

FIG. 1a shows a perspective view of a phototherapy pad in accordance with the present invention;

FIG. 1b shows an exploded view of a charging assembly of the phototherapy pad shown in FIG. 1;

FIG. 2 shows a perspective view of a fixing seat of the charging assembly shown in FIG. 1b in accordance with the present invention;

FIG. 3 shows a perspective view of a first cover plate illustrating an internal structure of the fixing seat in accordance with the present invention;

FIG. 4 shows a perspective view of a charging interface of the charging assembly in accordance with the present invention;

FIG. 5 shows an exploded view of a charging assembly in accordance with one of the alternative embodiments of the present invention;

FIG. 6 shows an exploded view of the phototherapy pad in accordance with the present invention;

FIG. 7 shows a perspective view of a phototherapy cap in accordance with one of the embodiments of the present invention; and

FIG. 8 shows a perspective view of the phototherapy pad in accordance with another embodiment of the present invention.

### DETAILED DESCRIPTION

An embodiment of this invention, illustrating its features, will now be described in detail. The words "comprising," "having," "containing," and "including," and other forms thereof, are intended to be equivalent in meaning and be open-ended in that an item or items following any one of these words is not meant to be an exhaustive listing of such item or items, or meant to be limited to only the listed item or items.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The disclosed embodiments are merely exemplary of the invention, which may be embodied in various forms.

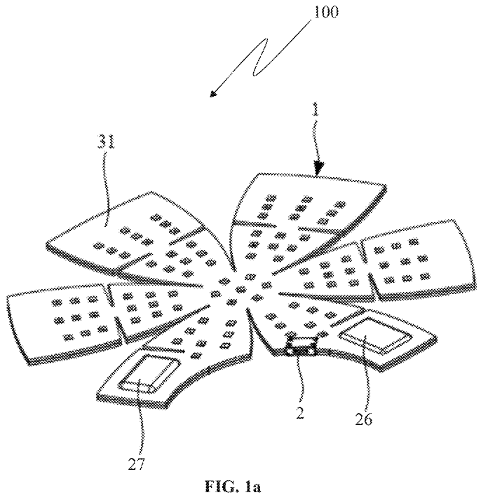

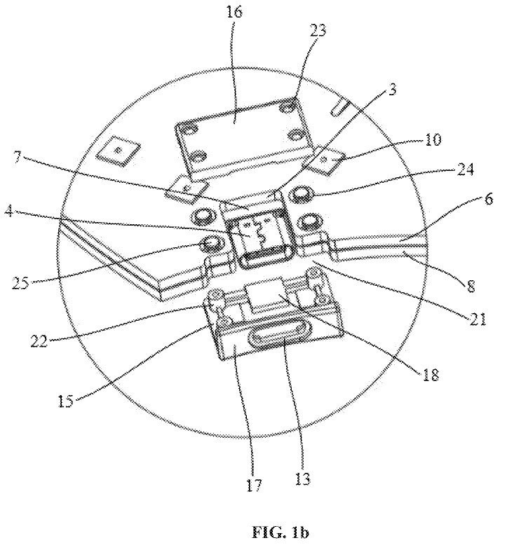

Referring now to FIGS. 1a and 1b, a phototherapy pad 100 in accordance with the present invention is illustrated. The phototherapy pad 100 includes a body 1 and a charging assembly 2. The body 1 includes a peripheral edge and a receiving notch 3 formed along the peripheral edge thereof. Specifically, the body 1 is configured to contact the skin and to emit light of a specific wavelength to provide phototherapy. The receiving notch 3 arranged at the edge of the body 1 provides an installation position for the charging assembly 2 and facilitates charging operations.

Specifically, the charging assembly 2 includes a charging interface 4 and a fixing seat 5. The charging interface 4 is fixedly arranged within the receiving notch 3 and is electrically connected to the body 1. The charging interface 4 of the charging assembly 2 is connected to an external power source through a charging cable to supply power to the body 1.

Further, the fixing seat 5 is attached to the body 1 at the receiving notch 3 to securely fix the charging interface 4 to the body 1. The fixing seat 5 prevents the charging interface 4 from causing tearing of the body 1 due to repeated plugging and unplugging and also prevents the charging interface 4 from becoming loose.

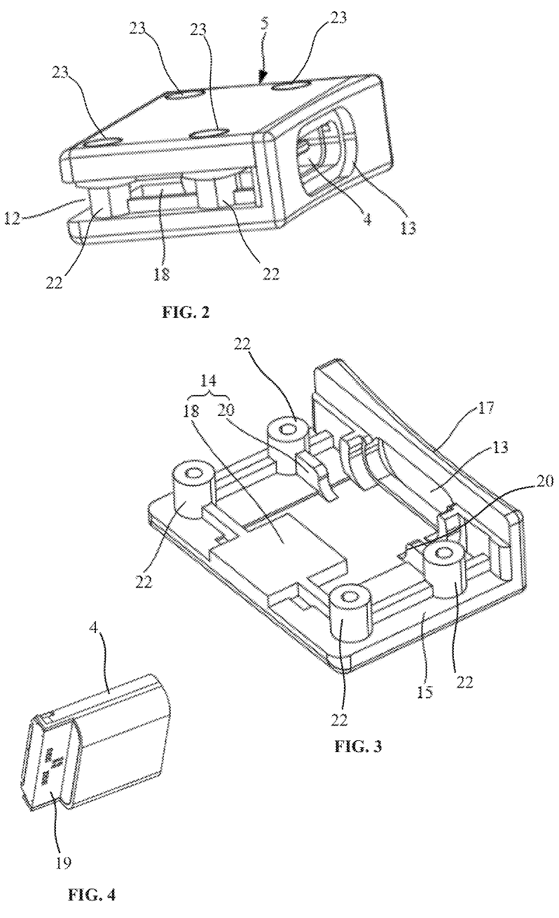

Referring now to FIGS. 1a, 1b, and 2, the fixing seat 5 covers the receiving notch 3. Specifically, the fixing seat 5 includes an accommodating cavity 12 configured to receive the charging interface 4 therein. Further, the fixing seat 5 comprises an insertion hole 13 aligned with the charging interface 4. The fixing seat 5 is provided on a side adjacent to an opening of the receiving notch 3, with the insertion hole 13 connecting to the accommodating cavity 12. The insertion hole 13 is aligned with the charging interface 4, such that a charging cable is directly connected to the charging interface 4 through the insertion hole 13 to enable convenient charging.

Specifically, the fixing seat 5 includes a first cover plate 15, a second cover plate 16 arranged opposite to the first cover plate 15, and a side cover plate 17. The first cover plate 15 is arranged on one side of the receiving notch 3 along a thickness direction of the body 1. The second cover plate 16 is arranged on the other side of the receiving notch 3 opposite to the first cover plate 15. The side cover plate 17 is arranged to join a portion of the first cover plate 15 to the second cover plate 16 to configure the accommodating cavity 12 therein. The side cover plate 17 connects the first cover plate 15 and the second cover plate 16, thereby forming the accommodating cavity 12 for accommodating the charging interface 4. The side cover plate 17 covers the opening of the receiving notch 3 and is provided with the insertion hole 13.

Specifically, the first cover plate 15 and the second cover plate 16 are respectively arranged on opposite sides of the body 1 in the thickness direction thereof, and correspondingly cover two sides of the receiving notch 3.

Further, the fixing seat 5 includes at least one limiting structure 14. The accommodating cavity 12 securely receives the charging interface 4 using the at least one limiting structure 14. The at least one limiting structure 14 is used to limit and retain the charging interface 4. The at least one limiting structure 14 is provided on an inner side of the first cover plate 15 and is arranged adjacent to the receiving notch 3 to engage with the charging interface 4.

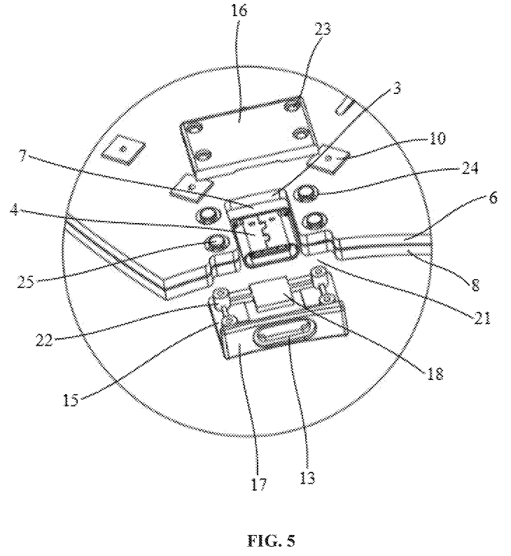

Referring now to FIGS. 1b, 2, 3 and 4, the limiting structure 14 comprises a limiting protrusion 18 configured to limit the movement of the charging interface 4 in a length direction. The limiting protrusion 18 is arranged on the inner side of the first cover plate 15, away from the side cover plate 17. The limiting protrusion 18 extends from the inner side of the first cover plate 15 towards the second cover plate 16. The limiting protrusion 18 is arranged on a rear portion of the inner side of the first cover plate 15 to engage with a first stepped groove 19 of the charging interface 4.

The first stepped groove 19 is formed on a rear side of an end of the charging interface 4, away from the insertion hole 13. The first stepped groove 19 engages with the limiting protrusion 18, such that the limiting protrusion 18 presses the charging interface 4 toward the side cover plate 17.

When the charging interface 4 is installed, the first stepped groove 19 engages with the limiting protrusion 18. After insertion of the charging interface 4, the limiting protrusion 18 applies force from the rear end of the charging interface 4, thereby pressing the charging interface 4 against the side cover plate 17 to fix the charging interface 4 in position.

The limiting protrusion 18 and the first stepped groove 19 firmly retain the charging interface 4 in the length direction, thereby avoiding displacement or loosening caused by external forces, such as repeated insertion and removal of the charging cable.

Further, the at least one limiting structure 14 includes limiting brackets 20 arranged on the inner side of the first cover plate 15, adjacent to the insertion hole 13. The limiting brackets 20 are configured to limit the movement of the charging interface 4 in a lateral direction. The limiting brackets 20 are arranged on opposite sides of the first cover plate 15 along the length direction of the insertion hole 13 to laterally restrain the charging interface 4. The charging interface 4 is retained between the limiting brackets 20 on both sides.

Specifically, the limiting brackets 20 are support structures arranged on both sides of the charging interface 4. The limiting brackets 20 have a curved shape to conform to the shape of the charging interface 4. The limiting brackets 20 provide lateral support for the charging interface 4, thereby ensuring that the charging interface 4 remains stable in a width direction and preventing lateral movement or displacement. The charging interface 4 is not only retained in the length direction by the limiting protrusion 18 and the first stepped groove 19 but is also limited and supported in the width direction by the limiting brackets 20.

In an alternative embodiment, the limiting structure 14 is configured in any form and is not limited to a particular form and may take various forms, such as protrusions, grooves, or other mechanical fixing structures. The charging interface 4 is positioned in cooperation with the limiting structure 14, and movement or shaking of the charging interface 4 is restricted by the limiting action of the limiting structure 14.

Referring now to FIG. 5, in an embodiment, the first cover plate 15 and the second cover plate 16 are detachably connected to the body 1 using a plurality of connecting posts 22, a plurality of first connecting holes 23, a plurality of second connecting holes 24 and a plurality of fasteners 25.

Specifically, the plurality of connecting posts 22 are provided on the first cover plate 15. The plurality of connecting posts 22 extends from the inner side of the first cover plate 15 towards the second cover plate 16. In the present embodiment, the plurality of connecting posts 22 are arranged at the corners of the first cover plate 15. Further, the plurality of first connecting holes 23 are arranged on the second cover plate 16 corresponding to the plurality of connecting posts 22. In the present embodiment, the plurality of first connecting holes 23 are arranged at the corners of the second cover plate 16. The plurality of connecting posts 22 are configured to receive the plurality of fasteners 25 through the plurality of first connecting holes 23 to attach the second cover plate 16 to the first cover plate 15.

The plurality of second connecting holes 24 are arranged on the body 1 corresponding to the plurality of connecting posts 22 and the plurality of first connecting holes 23.

Further, the plurality of fasteners 25 are passed through the plurality of first connecting holes 23 and the plurality of second connecting holes 24 to engage with the plurality of connecting posts 22, thereby clamping the body 1 between the first cover plate 15 and the second cover plate 16. The plurality of fasteners 25 are bolts or rivets that can pass through the plurality of first connecting holes 23 and the plurality of second connecting holes 24, and engage with the plurality of connecting posts 22, thereby securing the first cover plate 15 and the second cover plate 16 to the body 1. Further, each layer of the body 1 is provided with the plurality of second connecting holes 24 corresponding to the plurality of connecting posts 22. When replacement or repair of the charging interface 4 is required, the plurality of fasteners 25 are removed so that the first cover plate 15 and the second cover plate 16 can be quickly separated, thereby exposing the charging interface 4. The detachable arrangement allows quick assembly and disassembly of the fixing seat 5, thereby facilitating installation, maintenance, and replacement of the charging interface 4.

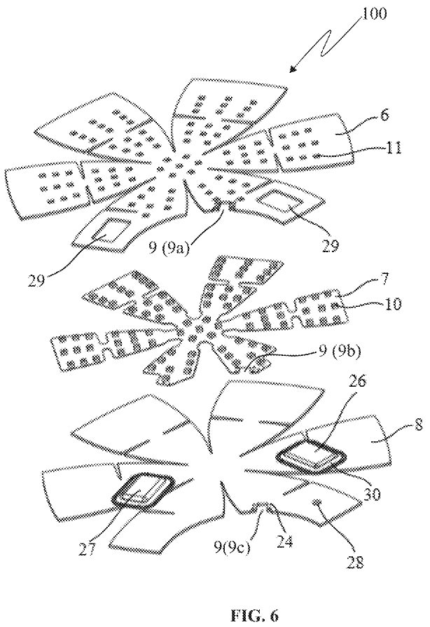

In an embodiment, as shown in FIG. 6, the body 1 includes a light-transmitting layer 6, a lamp board 7, and a backlight layer 8. The light-transmitting layer 6 is connected to the backlight layer 8. The lamp board 7 is arranged between the light-transmitting layer 6 and the backlight layer 8. The light-transmitting layer 6, the lamp board 7, and the backlight layer 8 are each provided with avoidance notches 9 on corresponding edges. When the light-transmitting layer 6, the lamp board 7, and the backlight layer 8 are stacked, the receiving notch 3 is formed by the avoidance notches 9a, 9b, 9c of the respective layers. In an embodiment, the light-transmitting layer 6, the lamp board 7, and the backlight layer 8 are sequentially stacked and integrally formed using hot pressing, bonding, or injection molding. The avoidance notches 9a, 9b, 9c from the respective layers together form the receiving notch 3 to facilitate installation of the charging assembly 2.

In the present embodiment, the light-transmitting layer 6 is formed of silicone to allow light emitted by the lamp board 7 to pass therethrough and reach a user's skin, while also providing a soft and comfortable contact surface. It is obvious for a person skilled in the art to form the light-transmitting layer 6 with any other light-transmitting material to ensure effective light transmission and also improve safety and comfort during use.

The lamp board 7 includes a portion of an edge protruding from the receiving notch 3 (as shown in FIG. 5), to facilitate an electrical connection between the lamp board 7 and the charging interface 4. The lamp board 7 is a flexible plate, such that the lamp board 7 bends and conforms to the shape of the body 1, thereby better fitting the contours of the human body. The lamp board 7 includes a plurality of lamp beads 10 distributed on the lamp board 7 to generate therapeutic light. The plurality of lamp beads 10 are configured to generate therapeutic light, including red light, infrared light, yellow light, or blue light. The plurality of lamp beads 10 has specific wavelengths or other light sources.

Further, the light-transmitting layer 6 is provided with light-transmitting holes 11 to improve light output. The light-transmitting holes 11 are arranged according to a layout of the plurality of lamp beads 10 on the lamp board 7. Each lamp bead of the plurality of lamp beads 10 is aligned with the corresponding light-transmitting hole 11. In this way, the light emitted by the plurality of lamp beads 10 passes outwardly through the corresponding light-transmitting holes 11, thereby improving the phototherapy effect. Furthermore, this arrangement helps to maintain a close fit between the lamp board 7 and the light-transmitting layer 6, thereby improving structural stability and durability.

Moreover, the backlight layer 8 is formed of silicone or another backing material. The backlight layer 8 is provided to protect the lamp board 7 and provide cushioning to reduce damage to the lamp board 7 from external pressure. Further, the backlight layer 8 assists in reflecting light, such that light emitted by the lamp beads 10 on the lamp board 7 is directed toward the light-transmitting layer 6, thereby improving phototherapy efficiency.

Referring now to FIGS. 5 and 6, the light-transmitting layer 6, the lamp board 7, and the backlight layer 8 are each provided with avoidance notches 9a, 9b, 9c, which together form a thicker receiving notch 3 when stacked. The receiving notch 3 extends through the body 1 in the thickness direction. The first cover plate 15 is arranged on the backlight layer 8 and covers one side of the receiving notch 3, and the second cover plate 16 is arranged on the light-transmitting layer 6 and covers the other side of the receiving notch 3.

In other embodiments (not shown), the light-transmitting layer 6 and the lamp board 7 are not provided with the avoidance notch 9, and only the backlight layer 8 is provided with the avoidance notch 9, such that the receiving notch 3 is formed when the layers are stacked. In this case, the light-transmitting layer 6 and the lamp board 7 cover one side of the receiving notch 3, and the charging interface 4 is electrically connected to the lamp board 7 and located within the receiving notch 3. The receiving notch 3 does not extend through the body 1 but instead forms a groove-like structure. The first cover plate 15 is arranged on the backlight layer 8 and covers the other side of the receiving notch 3, such that the charging interface 4 within the receiving notch 3 is retained by the limiting structure 14 on the first cover plate 15. The second cover plate 16 is arranged on the light-transmitting layer 6.

In another embodiment (not shown), only the light-transmitting layer 6 is provided with the avoidance notch 9, while the lamp board 7 and the backlight layer 8 are not provided with the avoidance notch 9. When stacked, the light-transmitting layer 6, the lamp board 7 and the backlight layer 8 form the receiving notch 3. In this case, the lamp board 7 and the backlight layer 8 cover one side of the receiving notch 3, and the charging interface 4 is electrically connected to the lamp board 7 and located within the receiving notch 3. The receiving notch 3 does not extend through the body 1 but instead forms a groove-like structure. The first cover plate 15 is arranged on the light-transmitting layer 6 and covers the other side of the receiving notch 3, such that the charging interface 4 within the receiving notch 3 is retained by the limiting structure 14 on the first cover plate 15. The second cover plate 16 is arranged on the backlight layer 8.

Referring now to FIG. 5, the body 1 includes a second stepped groove 21 provided at the opening of the receiving notch 3, and the side cover plate 17 is inserted in the second stepped groove 21 to flush the side cover plate 17 within the peripheral edge of the body 1. Specifically, the second stepped groove 21 is formed at the opening of the receiving notch 3 and provides a precise installation position for the side cover plate 17 of the fixing seat 5, thereby ensuring that the side cover plate 17 can be accurately and securely fixed at the receiving notch 3. In this embodiment, the side cover plate 17 is shaped and dimensioned to fit into the second stepped groove 21, to securely fix the side cover plate 17 at the opening of the receiving notch 3.

The second stepped groove 21 provides a clear positioning reference for the side cover plate 17, making the assembly process more intuitive and convenient. The side cover plate 17 is aligned and inserted into the second stepped groove 21 to complete the installation without requiring complex adjustments or additional fixing steps, thereby improving assembly efficiency. Further, the side cover plate 17 being flush with the edge at the opening of the receiving notch 3 gives the overall structure a cleaner and more integrated appearance and improves product aesthetics.

Referring to FIGS. 2, 3, and 5, the first cover plate 15 and the second cover plate 16 are integrally formed with the side cover plate 17. For example, the first cover plate 15 and the side cover plate 17 are designed as a one-piece component manufactured in the same molding process, such as injection molding. During assembly, the one-piece component, including the first cover plate 15 and the side cover plate 17, is first fitted onto the receiving notch 3 of the body 1. The one-piece design makes positioning more accurate, and installation simpler and faster. Thereafter, the second cover plate 16 is placed on the other side of the receiving notch 3 to fit closely with the side cover plate 17. At that time, the charging interface 4 is already positioned within the accommodating cavity 12 and retained by the limiting protrusion 18, the limiting brackets 20, or both.

Further, in an alternative embodiment (not shown), the second cover plate 16 and the side cover plate 17 are designed as a one-piece component manufactured in the same molding process. During assembly, the one-piece component, including the second cover plate 16 and the side cover plate 17, is first fitted onto the receiving notch 3 of the body 1. And thereafter, the first cover plate 15 is placed on the other side of the receiving notch 3 to fit closely with the side cover plate 17.

By adopting a structure in which one of the cover plates and the side cover plate 17 is integrally formed, the assembly process of the fixing seat 5 can be simplified, assembly efficiency can be improved, and structural stability can be enhanced.

Referring now to FIGS. 1a, and 6, the phototherapy pad 100 further includes a control box 26 and a power supply 27 integrally arranged on the body 1. Specifically, the control box 26 and the power supply 27 are directly integrated with the body 1 and electrically connected to the lamp board 7. The power supply 27 is configured to supply power to the phototherapy pad 100 and is charged through the charging interface 4.

The control box 26 may be provided with buttons (not shown) by which a user may control functions of the device, such as turning the device on or off and switching phototherapy modes, for example, by adjusting light intensity or wavelength.

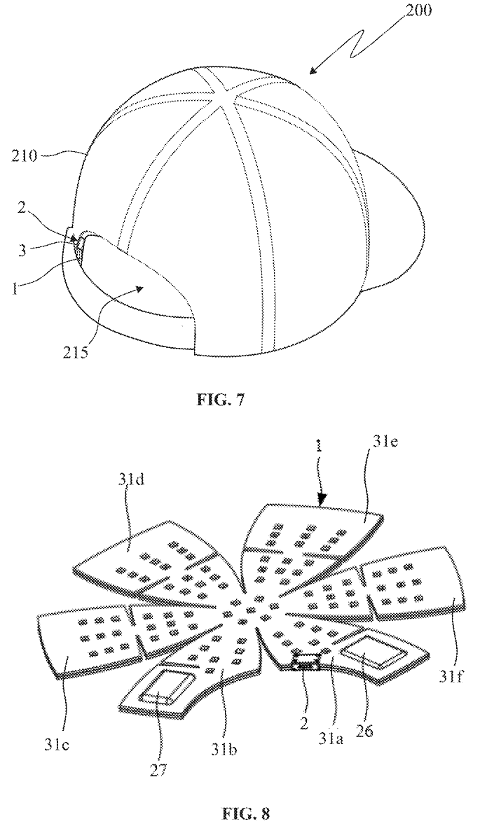

In an embodiment, as shown in FIG. 6, the backlight layer 8 of the body 1 is provided with a first through hole 28. The first through hole 28 is configured to allow buttons to be exposed for operation. Particularly, the buttons are arranged on the side of the body 1 facing away from the lamp beads 10. When the phototherapy pad 100 is used in a phototherapy cap 200 (as shown in FIG. 7), the buttons are adjacent to the inner surface of the cap body 210. The user can operate the buttons by pressing the corresponding markings. The markings include patterns, letters, or colors, on an outer surface of the cap body 210, thereby improving the user experience.

Further, the light-transmitting layer 6 of the body 1 is provided with a second through hole 29. The second through hole 29 is provided to partially expose the control box 26 and the power supply 27 for improving heat dissipation. In an embodiment, the control box 26 and the power supply 27 may be provided with flanges 30. The light-transmitting layer 6 may be pressed onto the flanges 30 during molding to achieve fixing and sealing of the control box 26 and the power supply 27.

During manufacturing, the control box 26 and the power supply 27 are first fixed to the backlight layer 8 and electrically connected to the lamp board 7. Thereafter, the light-transmitting layer 6 is formed by injection molding to receive the flanges 30 of the control box 26 and the power supply 27 for tight integration with the light-transmitting layer 6, thereby achieving an integrated structure.

In an embodiment, as shown in FIGS. 6, 7, and 8, the phototherapy pad 100 is arranged within the phototherapy cap 200. The phototherapy cap includes a cap body 210. The cap body 210 includes a notch 215 arranged at a rear portion of the cap body 210 for connecting an elastic band. The phototherapy pad 100 is arranged on an inner side of the cap body 210, and the body 1 is arranged along an edge adjacent to the notch 215 in such a way that the receiving notch 3 (shown in FIG. 5) is accessed through the notch 215 of the cap body 210.

Specifically, the cap body 210 is the main part of the phototherapy cap and is worn on the user's head. The notch 215 formed at the rear portion of the cap body 210 is configured for connection of the elastic band to accommodate different head sizes and ensure wearing comfort and stability.

The phototherapy pad 100 is arranged on the inner side of the cap body 210 and directly contacts the user's scalp. The light-transmitting layer 6 faces the scalp, and the plurality of lamp beads 10 of the lamp board 7 emit light of a specific wavelength toward the scalp to stimulate hair follicle activity and promote blood circulation, thereby helping improve hair loss conditions. Further, the backlight layer 8 of the phototherapy pad 100 is detachably connected to the cap body 210 by magnetic members, hook-and-loop fasteners, snap-fit members, or the like, thereby facilitating cleaning and maintenance. It may be obvious for a person skilled in the art to provide any other mechanism to connect the phototherapy pad 100 to the cap body 210.

The body 1 includes a plurality of pad bodies (31a, 31b, 31c, 31d, 31e, 31f) (shown in FIG. 8) arranged in a ring-like shape. One end of each pad body 31 of the plurality of pad bodies (31a, 31b, 31c, 31d, 31e, 31f) is connected to each other at a centre, and another end extends radially outward. The plurality of pad bodies (31a, 31b, 31c, 31d, 31e, 31f) are spaced apart from one another to form a radial structure. The radial structure allows the phototherapy pad 100 to bend to fit the cap body 210, thereby facilitating placement and assembly of the phototherapy pad 100 within the cap body 210.

Referring again to FIG. 8, the plurality of pad bodies (31a, 31b, 31c, 31d, 31e, 31f) includes a first pad body 31a, and a second pad body 31b adjacent to the notch 215 of the cap body 210. The control box 26 and the power supply 27 are respectively disposed on the first pad body 31a, the second pad body 31b. This arrangement improves assembly stability and facilitates heat dissipation.

Further, the first pad body 31a and the second pad body 31b are configured adjacent to the notch 215 of the cap body 210. Specifically, an edge shape of the first pad body 31a and the second pad body 31b are configured corresponding to an edge shape of the notch 215 of the cap body 210. In the present embodiment, the first pad body 31a and the second pad body 31b form an arcuate shape, which aligns with the shape of the notch 215. This arrangement prevents the phototherapy pad 100 from being exposed, thereby improving its appearance. Further, the first pad body 31a is provided with the receiving notch 3 for accommodating the charging assembly 2, thereby facilitating charging.

Therefore, the present invention has the advantage of providing a phototherapy pad 100. The fixing seat 5 of the phototherapy pad 100, which effectively reinforces the receiving notch 3 from both sides, improves the structural strength of that region, and prevents tearing or damage caused by repeated insertion and removal of the charging cable. Further, the fixing seat 5 covers the receiving notch 3, thereby covering and protecting the region of the receiving notch 3 and also enhancing the structural strength of that region. The fixing seat 5 prevents causing physical damage to the body 1 due to repeated insertion and removal of a charging cable. Furthermore, the fixing seat 5 covers and protects the charging interface 4, thereby providing a concealed arrangement that improves the appearance of the product and also extends the service life.

Moreover, the accommodating cavity 12 securely receives the charging interface 4 using the limiting structure 14 to ensure stable positioning of the charging interface 4 and reduce poor electrical contact caused by insertion and removal operations, movement, or vibration.

The charging interface 4 ensures that good electrical contact is maintained even during long-term use, thereby improving overall reliability. The fixing seat 5 enables easy and quick installation of the charging interface 4, since the charging interface 4 needs only to be properly inserted into the accommodating cavity 12 such that the first stepped groove 19 engages the limiting protrusion 18.

Even when the user repeatedly inserts and removes the charging cable, the charging interface 4 remains in a fixed position without becoming loose or tilted. This improves the stability of the charging interface 4, significantly reduces the risk of damage caused by repeated insertion and removal, and improves the service life of the product.

The foregoing descriptions of specific embodiments of the present invention have been presented for purposes of illustration and description. They are not intended to be exhaustive or to limit the present invention to the precise forms disclosed, and obviously, many modifications and variations are possible in light of the above teaching. The embodiments were chosen and described in order to explain the principles of the present invention best and its practical application, thereby enabling others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the scope of the claims of the present invention.

1. A phototherapy pad comprising:
a body having a peripheral edge and a receiving notch formed in the peripheral edge;
a charging assembly having a charging interface fixedly arranged within the receiving notch and electrically connected to the body, and a fixing seat attached to the body at the receiving notch, the fixing seat is having:
an accommodating cavity configured to receive the charging interface therein;
an insertion hole aligned with the charging interface; and
at least one limiting structure arranged within the accommodating cavity and configured to engage and retain the charging interface in a fixed position relative to the insertion hole to resist loosening of the charging interface during plugging and unplugging of a charging cable.

2. The phototherapy pad as claimed in claim 1, wherein the fixing seat includes a first cover plate, a second cover plate arranged opposite to the first cover plate and a side cover plate arranged to join a portion of the first cover plate to the second cover plate to configure the accommodating cavity therein.

3. The phototherapy pad as claimed in claim 1, wherein the at least one limiting structure is provided on an inner side of a first cover plate, arranged adjacent to the receiving notch to engage with the charging interface.

4. The phototherapy pad as claimed in claim 3, wherein the limiting structure comprises a limiting protrusion configured to limit movement of the charging interface in a length direction.

5. The phototherapy pad as claimed in claim 4, wherein the limiting protrusion is arranged on a rear portion of an inner side of the first cover plate to engage with a first stepped groove of the charging interface.

6. The phototherapy pad as claimed in claim 3, wherein the at least one limiting structure includes limiting brackets arranged on an inner side of the first cover plate, adjacent to an insertion hole, the limiting brackets are configured to limit movement of the charging interface in a lateral direction.

7. The phototherapy pad as claimed in claim 6, wherein the limiting brackets are arranged on opposite sides of the charging interface along a length direction of the insertion hole to laterally restrain the charging interface.

8. The phototherapy pad as claimed in claim 2, wherein the first cover plate and the second cover plate are detachably connected to the body using a plurality of connecting posts, a plurality of first connecting holes, a plurality of second connecting holes and a plurality of fasteners.

9. The phototherapy pad as claimed in claim 8, wherein the plurality of connecting posts are provided on the first cover plate, the plurality of first connecting holes are arranged on the second cover plate corresponding to the plurality of connecting posts, the plurality of second connecting holes are arranged on the body corresponding to the plurality of connecting posts and the plurality of first connecting holes, wherein the plurality of fasteners are passed through the plurality of first connecting holes and the plurality of second connecting holes to engage with the plurality of connecting posts, thereby clamping the body between the first cover plate and the second cover plate.

10. The phototherapy pad as claimed in claim 1, wherein the body includes a second stepped groove provided at opening of the receiving notch, and a side cover plate is inserted in the second stepped groove to flush the side cover plate within the peripheral edge of the body.

11. The phototherapy pad as claimed in claim 1, wherein the phototherapy pad is arranged within a phototherapy cap having a cap body, the phototherapy pad is arranged on an inner side of the cap body along an edge adjacent to a notch of the cap body to allow the receiving notch to be accessed through the notch.

12. A phototherapy cap comprising:
a cap body adapted to be worn on user's head, the cap body includes a notch arranged at a rear portion of the cap body for connecting an elastic band;
a phototherapy pad according to any of the preceding claims, arranged on an inner side of the cap body, along an edge adjacent to the not ch to allow the receiving notch to be accessed through the notch of the cap body.
